(19) United States
(12) Patent Application Publication
(10) Pub. No.: US 2022/0277308 A1
(43) Pub. Date: Sep. 1, 2022

(54) SYSTEMS AND METHODS FOR DETERMINING RISK OF IDENTITY FRAUD BASED ON MULTIPLE FRAUD DETECTION MODELS

(71) Applicant: Trans Union LLC, Chicago, IL (US)

(72) Inventors: Monique Ardizzi, Chicago, IL (US); Tian Shen, Chicago, IL (US); Andrew Sigfrid, Chicago, IL (US); Chris Dogas, Chicago, IL (US); Anne-Marie Kelly, Chicago, IL (US); Patrick Boudreau, Chicago, IL (US)

(21) Appl. No.: 17/236,164

(22) Filed: Apr. 21, 2021

(30) Foreign Application Priority Data
Mar. 1, 2021 (CA) 3110789

(51) Int. Cl. G06Q 20/40; G06Q 40/02

(52) U.S. Cl. CPC G06Q 20/4016; G06Q 40/025

(57) ABSTRACT

A fraud risk determination system that provides a comprehensive approach to multiple different types of fraud that outputs a single identity fraud risk score based on dynamically combining several independent fraud component models which employ various analytical techniques.

### CROSS REFERENCE TO RELATED APPLICATIONS

This application claims priority to Canadian Patent Application No. 3110789, which was filed on Mar. 1, 2021, the entire contents of which is incorporated herein by reference.

### TECHNICAL FIELD

The present disclosure relates to a fraud risk determination system and method that provides an identity fraud risk score that is simultaneously predictive of multiple different types of identity fraud.

### BACKGROUND

Financial services organizations compete on their ability to deliver relatively simple and speedy credit and loan origination processes to give consumers access to funds as quickly as possible. Moreover, when interacting with such financial services organizations via online channels, consumers expect relatively easy, frictionless experiences with a relatively high level of protection and privacy.

However, the credit and lending market has a significant level of unmitigated fraud loss risk. For example, while new account fraud (e.g., fraud that generally occurs on an account within the first 90 days that the account is open evidencing that the account was opened with the intent to commit fraud) and account takeover (e.g., identity theft where a bad actor gains unauthorized access to an account belonging to someone else) represent the largest areas of liability for many organizations, fraud comes in many different forms. Since various types of fraud simultaneously exist and a particular behavioral pattern may indicate one type of fraud and not another type of fraud (or even indicate a level trustworthiness), previous attempts to try and predict multiple types of fraud with a single predictive model have failed due to the inability to account for how behavioral patterns represents different meanings for different types of fraud. Accordingly, unlike in the field of credit risk, where the process for a consumer to proceed to a default status or declare bankruptcy are relatively finite in how they can occur, fraudulent applications can occur in countless ways facilitated through several different channels, utilizing several different tactics with personal information that may have been exposed through countless avenues.

Compounding these issues is that fraudsters often adapt to leverage increasingly complex mechanisms to expose identities and facilitate fraudulent activities, thereby increasing the gap in sophistication between the fraudster' s techniques and the fraud prevention solutions currently available. For example, while attempts have been made to build a model that predicts a particular type of fraud individually, such a model fails to account for other types of fraud and further risks losing performance relatively quickly as fraudsters alter how they perpetrate that type of fraud (and/or switch to a different type of fraud altogether) resulting in limited use of that specific model. Accordingly, the distribution of the tactics employed by fraudsters is an ever-evolving landscape wherein as lenders begin to even attempt to solution for and close gaps on the current types of frauds that are exposing their strategies, the fraudsters develop new tactics and increase their level of sophistication. This vicious cycle continually repeats resulting in predictive fraud models often degrading without a more robust solution in place.

Against this background of increasing attempts to defraud consumers, financial services organizations strive to provide friction-right experiences, with minimal impact to “good” consumers as well as reduction of manual reviews which slow down the credit and loan origination process and delay consumers access to funds. Therefore, a continuing need exists to build additional identity capabilities, eliminate blind spots and white space often leveraged by bad actors attempting to gain illegitimate and fraudulent access while not overburdening consumers and financial services organizations in doing so.

### SUMMARY

In certain embodiments, the present disclosure relates to a fraud risk determination system including a processor, and a memory device that stores a plurality of instructions. When executed by the processor responsive to an initiated transaction, the instructions cause the processor to receive transaction data associated with an entity, and for each of a plurality of different fraud component models, determine, based on at least a portion of the received transaction data, an individual fraud predictor associated with that fraud component model, wherein each individual fraud predictor is determined independent of each of the other individual fraud predictors. When executed by the processor responsive to the initiated transaction, the instructions cause the processor to determine, based on a dynamic weighting of each of the determined individual fraud predictors associated with each of the fraud component models, a single identity fraud risk score associated with the entity.

In certain embodiments, the present disclosure relates to a method of operating a fraud risk determination system. Responsive to an initiated transaction, the method includes receiving transaction data associated with an entity, and for each of a plurality of different fraud component models, determining, by a processor and based on at least a portion of the received transaction data, an individual fraud predictor associated with that fraud component model, wherein each individual fraud predictor is determined independent of each of the other individual fraud predictors. The method also includes determining, by the processor and based on a dynamic weighting of each of the determined individual fraud predictors associated with each of the fraud component models, a single identity fraud risk score associated with the entity.

These and other embodiments, and various permutations and aspects, will become apparent and be more fully understood from the following detailed description and accompanying drawings, which set forth illustrative embodiments that are indicative of the various ways in which the principles of the disclosure may be employed.

### BRIEF DESCRIPTION OF THE DRAWINGS

FIG. 1 is a block diagram illustrating a fraud risk determination system according to certain embodiments of the present disclosure.

FIG. 2 is a flowchart illustrating the fraud risk determination system determining an identity fraud risk score in accordance with certain embodiments of the present disclosure.

FIG. 3 is a block diagram of one form of a computer or server included in FIG. 1, having a memory element with a computer readable medium for implementing the example operations of FIG. 2 in accordance with certain embodiments of the present disclosure.

### DETAILED DESCRIPTION

The description that follows describes, illustrates and exemplifies one or more particular embodiments of the present disclosure in accordance with its principles. This description is not provided to limit the present disclosure to the embodiments described herein, but rather to explain and teach the principles of the present disclosure in such a way to enable one of ordinary skill in the art to understand these principles and, with that understanding, be able to apply them to practice not only the embodiments described herein, but also other embodiments that may come to mind in accordance with these principles. The scope of the present disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the present disclosure as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

It should also be noted that the disclosures made in this specification are in accordance with the principles of the embodiments(s), which are intended to be disclosed or interpreted to their broadest extent under the patent laws, and while such disclosure may describe or otherwise cover subject matter that may be regulated by other existing federal or regional/provincial laws or regulations, including, without limitation, the U.S. Fair Credit Reporting Act (FCRA), the U.S. Equal Credit Opportunity Act (ECOA), the U.S. Gramm-Leach-Bliley Act (GLBA), etc., nothing in this disclosure is intended to suggest or imply noncompliance with any such law or regulation by the assignee.

In various embodiments, the systems and methods of the present disclosure provide a comprehensive approach to multiple different types of fraud that outputs a single identity fraud risk score based on dynamically combining several independent fraud component models. The single identity fraud risk score predicts the likelihood that the source of an application for credit is trustworthy or not leveraging the intermediate results of each individual fraud component model. In these embodiments, rather than determining a score for each of a plurality of different types of fraud and then averaging out such scores to generate a single fraud score, the systems and methods of the present disclosure determine a single identity fraud risk score by accounting for how certain behaviors are indicative of certain types of fraud and yet not indicative of other types of fraud. For example, if a particular application exhibits a plurality of the signals of true name fraud (i.e., a true name fraud component model generates a high true fraud predictor and thus a relatively high likelihood that the application is associated with a perpetrated true name fraud) and little to none of the signals of synthetic fraud (i.e., a synthetic fraud component model generates a low synthetic fraud predictor and thus a relatively low likelihood that the application is associated with a perpetrated synthetic fraud), the system does not simply average these two fraud predictors together to result in a medium fraud predictor (i.e., a relatively medium likelihood that the application is associated with a perpetrated fraud). Rather, the systems and methods of the present disclosure weights the different individual fraud component model predictors differently to prevent the lack of signals of one type of fraud from reducing the identity fraud risk score when signals indicate another type of fraud may be being attempted. In this example, since the low likelihood of a synthetic fraud does not diminish the high likelihood of a true name fraud, the fraud risk determination system determines a relatively high identity fraud risk score which is reflective of the relatively high likelihood of an attempted fraud. Accordingly, such dynamic weightings of the individual fraud predictors associated with the different fraud component models enables the fraud risk determination system to output a single identity fraud risk score that simultaneously accounts for multiple different types of fraud.

More specifically, in operation, each independent fraud component model is associated with predicting or otherwise defining one particular type or aspect of identity management, such as a specific type of fraud, wherein the individual fraud predictors of that independent fraud component model identify unique patterns that exhibit that specific type of fraud. For example, a synthetic fraud component model identifies behavioral patterns, such as transaction patterns, that show up in synthetic fraud, while ignoring how such patterns affect true name fraud and all other indicators of fraud. In this example, by understanding the interplay of a particular behavioral pattern between different types of fraud and then isolating the analysis of that particular behavioral pattern to an individual type of fraud (while ignoring, for such analysis, the effects on other types of fraud), the systems and methods of the present disclosure enable the different fraud component models to generate more accurate results. Put differently, by utilizing a plurality of independent fraud component models that each focus on a particular type of fraud and then dynamically combining the individual fraud predictors of each independent fraud component model into a single identity fraud risk score, the systems and methods of the present disclosure provides an improved assessment of risk across different types of fraud while eliminating the recognized limitations from trying to predict an ‘all-fraud’ model.

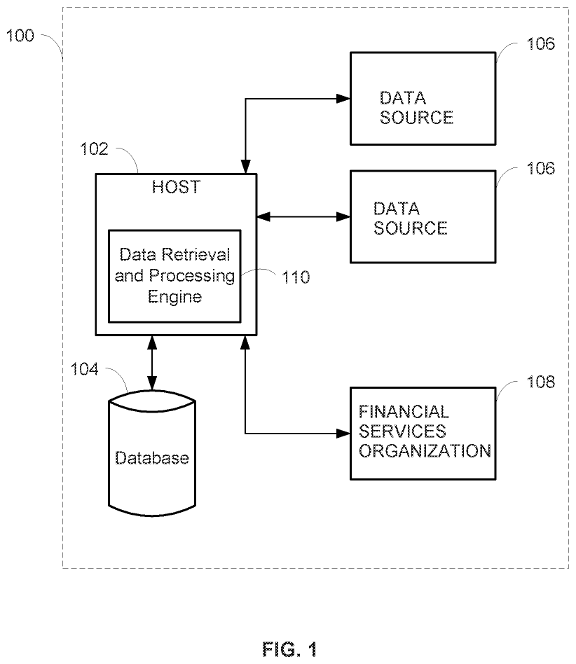

FIG. 1 illustrates one embodiment of a fraud risk determination system 100 for providing a singular identity fraud risk score employed in, amongst other uses, determining the trustworthiness of an entity, such as a consumer, in association with a given transaction. As used herein, “transaction” refers to the end-to-end entity experience, which may start with, for example, selecting an option to apply for a product or service and may end with, for example, a final decision (e.g., decline or approval) related to the product or service. As shown in FIG. 1, the fraud risk determination system 100 includes a host 102 for receiving, monitoring and analyzing transaction information and a database 104 for storing received transaction information and the results of any analysis. As also seen in FIG. 1, the fraud risk determination system 100 includes a plurality of data sources 106 in communication with the host 102, wherein the different data sources maintain different data sets that the host employs to determine the identity fraud risk score. As further seen in FIG. 1, the host 102 of the fraud risk determination system 100 is in communication with a financial services organization 108, such as a lender whom may potentially extend credit to the consumer based, at least in part, on the identity fraud risk score determined by the host. It should be appreciated that while illustrated as the fraud risk determination system being in communication with a component, such as a server, of a financial services organization, the fraud risk determination system of the present disclosure may be in communication with one or more components of other types of organizations that may require an identity fraud risk score of an entity, such as, but not limited to, insurance organizations, automobile lending organizations, retail merchants, telecommunication organizations, utilities (e.g., organizations that offer service accounts provided to homes and businesses, such as electricity, gas and water), peer-to-peer lending platforms, product rental organizations, employment screening organizations and/or governmental bodies.

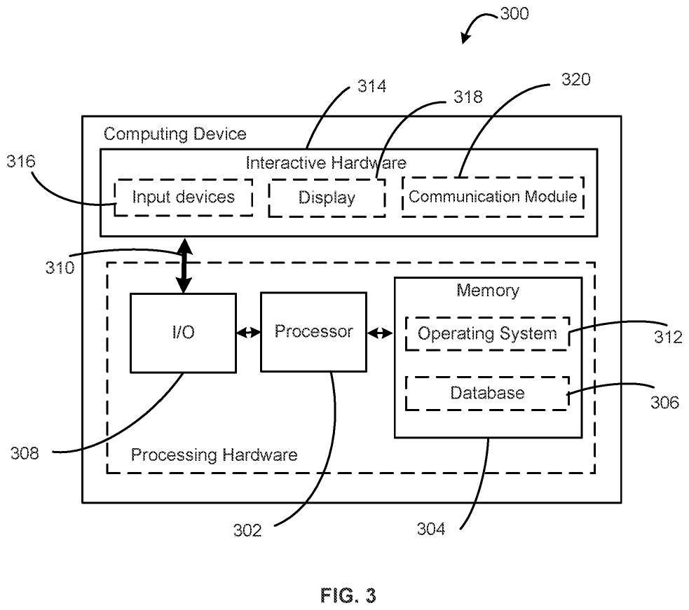

In various embodiments, the information stored in the database 104 includes any suitable financial information, identity information, behavioral information and/or identified fraud information employed to aid in determining the trustworthiness of a transaction, such as a credit and lending application with a potential borrower. In certain embodiments, the database 104 contains information obtained from the data sources which may be associated with the host or maintained independent of the host. For example, the information may be obtained from an extended network that includes not only one or more financial services organizations but other entities that are customers of, or otherwise associated with, the host 102. In such embodiments, the information output from the database 104 may be a compilation of the transaction information received from the financial services organization and the information received from any external data sources. In certain embodiments, the database 104 is included on a server comprising a processor and memory (see, e.g., FIG. 3) and the processor is configured to analyze the information stored in the database 104 in accordance with one or more preconfigured algorithms and provide the output of the algorithm in the form of an identity fraud risk score in response to a request for information from a financial services organization.

In certain embodiments, the database 104 is managed by the host 102, and the host 102 is configured to communicate information between the database 104 and the financial services organization 108. For example, a financial services organization 108 may provide information to the host 102 for entry into the database 104 in exchange for access to other information provided to or maintained by the database 104. More specifically, a financial services organization 108 may utilize a digital verification component associated with the system 100 and accessible by the financial services organization each time an application is opened and/or make an Application Programming Interface (“API”) call to request an identity fraud risk score associated with the application. As shown in FIG. 1, the host 102 includes a data retrieval and processing engine 110, which may receive the requests for borrower and other transaction information from the financial services organization 108 and retrieve the requested information from the database 104. In some embodiments, the engine 110 is also configured to analyze the data stored in the database 104, using one or more preconfigured algorithms, and determine the identity fraud risk score.

In certain embodiments, the data sources and/or the financial services organization that interact with the fraud risk determination system 100 employ a digital verification component provided by the host 102. The digital verification component can be a software program designed to provide greater visibility into devices, web browsing behaviors, and digital or device identities associated with one or more consumer. Each of the data sources 106 and/or the financial services organization 108 may use an API installed on, or accessible via, their respective computing devices (e.g., computing device 300 shown in FIG. 3) to interface with the system 100, including to provide information to the system 100. It should be appreciated that in certain embodiments, the different component of (or otherwise associated with) the fraud risk determination system may interact with one another through multiple channels. For example, the fraud risk determination system 100 is accessible through an online self-service system or API associated therewith. In other examples, the fraud risk determination system 100 is also accessible through phone or point of sale channels.

In certain embodiments, the different data sources maintain different data sets that individually or collectively are indicative of one or more behaviors of a consumer which the fraud risk determination system factors in when determining the identity fraud risk score. In certain embodiments, the different data sources additionally or alternatively maintain different data sets that individually or collectively are indicative of an identity of a consumer which the fraud risk determination system factors in when determining the identity fraud risk score. In certain embodiments, the different data sources additionally or alternatively maintain different data sets that individually or collectively are indicative of one or more fraud components which the consumer may be a victim of and which the fraud risk determination system factors in when determining the identity fraud risk score.

In certain embodiments, one or more fraud component models of the fraud risk determination system utilize data associated with the consumer, such as credit bureau data. In such embodiments, the data associated with the consumer that may be used to identify the consumer includes, but is not limited to, personal information of the consumer (e.g., name, date of birth, identification number (e.g., passport number, social security number, social insurance number, Permanent Account Number (PAN), voter identification number, driver's license number, ration card number, universal ID number (Aadhaar)), telephone numbers, addresses, and/or email addresses), address history of the consumer, and/or financial information of the consumer (e.g., financial institution names, account numbers, account balances, and/or payment history). In certain embodiments, one or more fraud component models of the fraud risk determination system additionally or alternatively utilize behavioral data (i.e., data employed to predict if a provided identity of a consumer would act in a certain way), wherein such data includes, but is not limited to inquiry data (e.g., a log of how identities are being used across lenders) such as data relating to inquiry timing and velocity (e.g., the speed at which transactions are happening to identify where the same identity elements and/or devices are being employed through various tactics to acquire several financial products quickly (usually with no intent to repay)).

In certain embodiments, one or more fraud component models of the fraud risk determination system additionally or alternatively utilize data associated with previously determined frauds (i.e., data indicative of suspicious actions identified as being associated with frauds known to be committed or attempted), wherein such data includes, but is not limited to, data on national fraud trends, and/or data on fraud patterns. In certain embodiments, one or more fraud component models of the fraud risk determination system additionally or alternatively utilize data regarding the various products, markets and/or application channels being used, the sequence of such activities, or a combination thereof. For example, one or more fraud component models used to determine the identity fraud risk score are at least partially based on a product attribute that identifies the type of product associated with the transaction (e.g., a lending product such as a home equity line of credit (HELOC), or an auto loan or a non-lending product) so that the transaction data can be segregated or aggregated data on a product level. In another example, one or more fraud component models used to determine the identity fraud risk score are at least partially based on an industry attribute that identifies the type of industry or market in which the transaction occurred (e.g., credit card issuer, unsecured personal lender, alternative short-term lender, or auto lender), so that the transaction data can be segregated or aggregated data on an industry level. In another example, one or more fraud component models used to determine the identity fraud risk score are at least partially based on a channel attribute that identifies the application channel used for the transaction (e.g., web, mobile, bank branch, dealership, retail point-of-conversion (POC), or call center), so that the transaction data can be segregated or aggregated on a channel level.

In operation, the fraud risk determination system (and specifically the host of the fraud risk determination system) utilizes data obtained from one or more data sources to individually and independently implement a fraud component model associated with predicting or defining one particular type or aspect of identity management. In these embodiments, each fraud component model of the fraud risk determination system identifies the patterns that exhibit a particular type of fraud while ignoring patterns that may or may not exhibit another type of fraud.

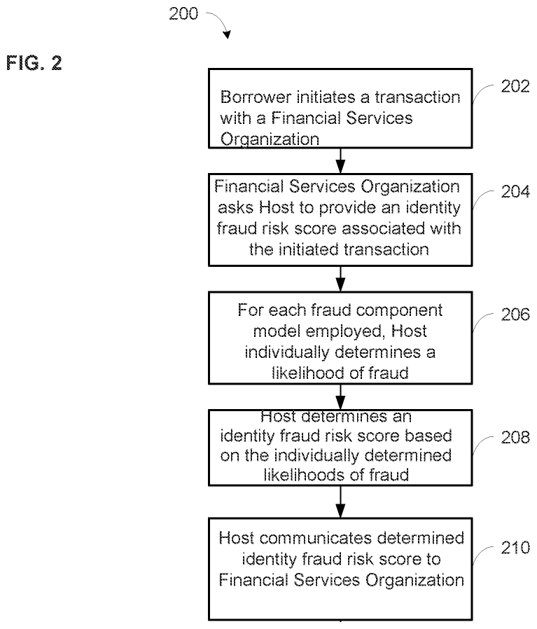

More specifically, as seen in FIG. 2, the fraud risk determination system (or more specifically, through interactions between various components of the fraud risk determination system 100 that are facilitated by software executing on one or more computer processors associated with the components) employs process 200 to determine an identity fraud risk score based on the individual fraud predictors of a plurality of different fraud component models that each focus on a different aspect of identity fraud.

In the illustrated embodiment, the process 200 begins at step 202 with a borrower initiating a transaction with a financial services organization, for example, by applying for a loan. At step 204, in an attempt to verify an identity of the borrower, the financial services organization requests the host to provide an identity fraud risk score associated with the initiated transaction. Such an identity fraud risk score aids the financial services organization in determining whether or not to proceed with the initiated transaction (e.g., the loan application). It should be appreciated that in addition to requesting the identity fraud risk score described herein, the financial services organization may also request additional information that involves the borrower based on the borrower's personal identity information, device identity information, or other transaction attributes associated with the pending transaction and which the financial services organization may utilize in determining whether or not to proceed with the initiated transaction.

In the illustrated embodiment, at step 206, in response to the request for an identity fraud risk score, for each fraud component model employed, the host determines a likelihood of fraud. In such embodiments, the host utilizes data obtained from one or more data sources to predict a likelihood of a particular type of identity fraud or a likelihood of an occurrence of any identity fraud. Put differently, for each of a plurality of individual fraud component models, the fraud risk determination system separately determines an individual fraud predictor, wherein such an individual fraud predictor is based on the factors accounted for by that individual fraud component model. It should be appreciated that given the interplay between different types of identity fraud and how the same behavior may register as suspicious for one type of identity fraud but be expected for another type of identify fraud, the host executes each fraud component model separately to specifically avoid any undue influence from one determination to another determination.

In one example embodiment, one of the fraud component models of the fraud risk determination system includes a synthetic fraud model configured to capture synthetic fraud. In this example embodiment, a synthetic fraud is a case where an application is submitted against a fictitious identity in an attempt to open credit in that name. Since fraudsters will often start small with fictitious identities to avoid suspicious and build the fictitious identity to attempt to blend in with an average consumer before applying to acquire larger loans and harvesting the fictitious identity, this fraud component model operates to detect applications that exhibit signals of synthetic fraud based on evidence that the identity may be fabricated. For example, if a synthetic identity is created by using a combination of real information, such as a legitimate Social Security number, and fictitious information, such as a false name, address, or date of birth, the fraud risk determination system utilizes data from one or more data sources to execute the synthetic fraud model to determine any inconsistencies between this real information associated with the consumer and any fictitious information not associated with the consumer (and/or determine a frequency of applications with any discrepancies in the consumer's personal identifying information) to detect or otherwise predict a likelihood that a synthetic fraud is associated with the consumer.

In another example embodiment, one of the fraud component models of the fraud risk determination system additionally or alternatively includes a true name fraud model configured to capture true name fraud. In this example embodiment, a true name fraud is a case where an application is submitted by a third-party on behalf of a true consumer without permission (e.g., a perpetrator is attempting to fraudulently open a loan or otherwise obtain credit in a true consumer's name). In operation, if a third-party fraudster has exposed aspects of a customer's identity in some way, such as via data breaches, phishing, and/or social engineering, and attempts to open credit in that identity's name, this fraud component model detects applications that exhibit signals of true name fraud based on evidence of such occurrences. For example, to detect or otherwise predict a likelihood that a true name fraud is associated with the consumer, the fraud risk determination system analyzes certain velocities associated with the consumer, such as by determining a number of credit files with the consumer's personal identifying information updated in the past X number of months and/or determining a number of inquiries with the consumer's personal identifying information in the past Y number of days, to determine if the consumer's personal identifying information is being overutilized evidencing suspicious behavior which signals true name fraud.

In another example embodiment, one of the fraud component models of the fraud risk determination system additionally or alternatively includes a fraud rules optimization model configured to leverage one or more specific decision trees to optimally represent a fraud ruleset to identify a specific fraud pattern (that may be preventable going forward). For example, to detect or otherwise predict a likelihood that a fraud is associated with a consumer, the fraud risk determination system employs a ruleset that if Customer City=“Toronto” and IP Address City=“Montreal” and Time of Day=3 a.m, then the attempted transaction is fraudulent. As illustrated by this example, the fraud rules optimization model analytically derives an optimal ruleset by leveraging data available from multiple data sources to determine and implement a ruleset that captures the maximum number of frauds employing the fewest number of rules and criteria possible while affecting the fewest “good customers” as possible.

In another example embodiment, one of the fraud component models of the fraud risk determination system additionally or alternatively includes fraud susceptibility clustering model configured to segment consumers based on their susceptibility to fraudulent activity. In this example embodiment, rather than waiting for a lender (or consortium of lenders) to observe one, two, three, or more cases of a particular fraud trend before being able to piece together the similarities, identify it as a trend, and begin solving for that fraud trend, the fraud risk determination system predicts new fraud trends by employing the fraud susceptibility clustering model. That is, given that there are certain consumers that are, based on their credit profiles and behaviors, inherently more susceptible to falling victim to fraud, the fraud susceptibility clustering model accounts for such consumers being part of (or not being part of) such a segment of more susceptible consumers. For example, a consumer may be at increased vulnerability to fraud because one of more of, the consumer's identity has been exposed through a breach and a consumer statement has been placed on their file, the consumer has relationships with many different institutions resulting in the consumer's identity being stored in a relatively high number of places, or the consumer's personal information has not changed in a relatively long amount of time so the consumer's personal information is still valid years after a breach (e.g., a consumer's address has not changed in twenty years so if the consumer's data was exposed even seven years ago, that information is still valid). In this example, the fraud susceptibility clustering model of the fraud risk determination system segments the population and then utilizes this segmenting to determine that certain of the segments are relatively more or less susceptible to different types of fraud than an average consumer.

In another example embodiment, one of the fraud component models of the fraud risk determination system additionally or alternatively includes a credit card propensity model configured to reduce false positives by predicting the likelihood that a particular consumer was likely to open a credit card trade. In this example embodiment, the fraud risk determination system employs the credit card propensity model to predict the likelihood that a consumer is in the market for applying for a new credit card tradeline over a future period of time, such as in the next three months. For example, if, based on data obtained from one or more data sources, the fraud risk determination system determines that a consumer has a relatively low likelihood to open a credit card tradeline, but the consumer's identity is currently being scored for opening a credit card, then this fraud component model of the fraud risk determination system indicates a relatively higher likelihood of fraud. On the other hand, if, based on data obtained from one or more data sources, the fraud risk determination system determines that a consumer has a relatively high likelihood to open a credit card tradeline and that consumer's identity is currently being scored for opening a credit card, then to reduce the chances of obtaining false-positives, this fraud component model of the fraud risk determination system indicates a relatively lower likelihood of fraud.

In another example embodiment, one of the fraud component models of the fraud risk determination system additionally or alternatively includes a early payment default model configured to detect applications that exhibit signals of never-pay behavior and are likely to proceed straight to having to be charged-off by the financial services organization. In this example embodiment, since it is often difficult to distinguish, at the time of application, whether such non- payment is a risk problem (e.g., the consumer may have had every intent to pay the loan but not have the ability to, thus entering arrears) or a fraud problem (e.g., the consumer may not have intended to pay the loan at all), the early payment default model utilizes data obtained from one or more data sources to distinguish between the two problems with a focus on capturing the fraud related cases. Specifically, based on a target definition of consumers who exhibited a relatively severe level of delinquency (e.g., consumers who proceeded to at least 120 days past due within the first six months of their loan) evidencing no intent to make any payments whatsoever, the early payment default model employs other predictors of this anticipated behavior.

In certain embodiments, the fraud risk determination system of the present disclosure separately employs each of the fraud component models disclosed herein to determine an individual fraud predictor associated with a predictable likelihood of a particular type of identity fraud or a likelihood of an occurrence of any identity fraud. In certain embodiments, the fraud risk determination system of the present disclosure separately employs a plurality of the fraud component models disclosed herein to determine an individual fraud predictor associated with a predictable likelihood of a particular type of identity fraud or a likelihood of an occurrence of any identity fraud. In these embodiments, the fraud risk determination system employs two or more of the fraud component models without utilizing one or more other fraud component models. It should thus be appreciated that the system maintains a dynamic configuration wherein which fraud component models to employ for a given determination and which of any fraud component models not to employ for that given determination may change based on the data obtained from one or more data sources, advances in identity fraud attempted to be perpetrated by fraudsters and/or the results of one or more fraud component models.

Returning to FIG. 2, following the determination of a likelihood of fraud for each employed fraud component model, at steps 208 and 210, the host determines an identity fraud risk score based on such individually determined likelihoods of fraud and communicates the determined identity fraud risk score to the financial services organization. That is, the host dynamically combines the results of a plurality of different fraud component models (which each determine an individual fraud predictor indicative of either a likelihood of a specific type of fraud or a likelihood of an occurrence of any type of fraud), using an ensemble model to form an identity fraud risk score that conveys to the financial services organization data associated with a singular relative likelihood that the borrow initiating the transaction with the financial services organization is whom they say they are. In these embodiments, the use of a single identity fraud risk score that accounts for multiple different types of fraud and situations in which a fraud may arise is relatively easier (compared to individual likelihoods for each of a plurality of different types of fraud) for the financial services organization to ingest and take action responsive to.

In certain embodiments, the identity fraud risk score includes a number from a designated range of numbers. For example, the fraud risk determination system utilizes a range of 1 to 999 to convey the identity fraud risk score, wherein a higher displayed number indicates a relatively higher probability that a fraud is being attempted and a lower displayed number indicates a relatively lower probability that a fraud is being attempted (or vice-versa). In certain embodiments, the identity fraud risk score additionally or alternatively includes a color from a designated range of colors. For example, the fraud risk determination system utilizes a red, yellow, green system wherein a displayed red identity fraud risk score indicates a relatively higher probability that a fraud is being attempted, a displayed yellow identity fraud risk score indicates a relatively medium probability that a fraud is being attempted and a displayed green identity fraud risk score indicates a relatively lower probability that a fraud is being attempted (or vice-versa).

In certain embodiments, to determine the identity fraud risk score based on the individually determined results of each of the employed fraud component models, the fraud risk determination system accounts for how certain behaviors are indicative of certain types of fraud and yet not indicative of other types of fraud. That is, rather than generating a single identity fraud risk score by simply averaging the results of the different fraud component models employed, in determining the identity fraud risk score, the fraud risk determination system factors in how certain behaviors have different effects on different fraud component models and the interplay such behaviors have between the different types of fraud screened for. For example, if the data associated with a particular application is indicative of a behavior that exhibits various signals of synthetic fraud (i.e., a synthetic fraud component model generates a high synthetic fraud score and thus a relatively high likelihood that the application is associated with a perpetrated synthetic fraud) and none of the signals of true name fraud (i.e., a true name fraud component model generates a low true name fraud score and thus a relatively low likelihood that the application is associated with a perpetrated true name fraud), the fraud risk determination system does not simply average these two fraud scores together to result in a medium fraud score (i.e., a relatively medium likelihood that the application is associated with a perpetrated fraud). Rather, the fraud risk determination system accounts for the interplay between these two different types of fraud and prevents the lack of signals of true name fraud from reducing the identity fraud risk score. In other words, since the low likelihood of a true name fraud does not diminish the high likelihood of a synthetic fraud, the fraud risk determination system determines a relatively high identity fraud risk score which is reflective of the relatively high likelihood of a fraud being associated with the borrower and/or the attempted transaction. Accordingly, the fraud risk determination system provides a comprehensive approach to multiple different types of fraud that outputs a single identity fraud risk score based on dynamically combining several independent fraud component models which employ various analytical techniques.

In certain embodiments, the fraud risk determination system 100 includes weighted algorithms used to factor in the different fraud component models to determine an identity fraud risk score associated with each transaction. In certain such embodiments, the fraud risk determination system 100 utilizes part or all of the information regarding a borrower that is stored in the database and/or received from one or more data sources as inputs to certain weighted algorithms to determine an identity fraud risk score associated with the borrower.

In certain embodiments, the fraud risk determination system determines reason codes from the individual components models by analyzing which fraud component models have the highest probability of that type of fraud and/or are the most impactful in scoring an application. Such reason codes enable the fraud risk determination system to better capture the complex relationships that exist when predicting fraud and isolate one particular type of potential fraud over another particular type of potential fraud. For example, if a particular application exhibited several signals of true name fraud, then the true name fraud component model would have a high probability and the other fraud component models may have average or lower probabilities. In this case, the fraud risk determination system would provide the true name fraud model as the number one reason code (because that fraud component model is proving to be the most symptomatic for this application) wherein a fraud investigator may utilize this reason code as a signpost to investigate this case as a true name fraud situation.

In certain embodiments, the host provides the identity fraud risk score which captures multiple types of fraud without providing the results of any of the individual fraud component models. In other embodiments, the host provides the identity fraud risk score which captures multiple types of fraud and also provides the results of any of the individual fraud component models. In different embodiments, the results of the individual fraud component models are provided with each identity fraud risk score or upon request by the financial services organization.

In certain embodiments, the ensemble framework of the fraud risk determination system enables the dynamic recalibration of one or more fraud component models employed as the distribution in market fraud types change. For example, as the prevalence of true name fraud or synthetic fraud rises or falls, the ensemble framework of the present disclosure may be relatively quickly recalibrated to reweight the overall importance of that particular fraud type. In certain other embodiments, the ensemble framework of the fraud risk determination system additionally or alternatively enables the dynamic recalibration of which fraud component models to employ as the distribution in market fraud types change. Such embodiments enable the fraud risk determination system to stay up-to-date on current fraud trends.

Various components of the system 100 may be implemented using software executable by one or more servers or computers, such as computing device 300 with a processor 302 and memory 304, as shown in FIG. 3, which is described in more detail below. For example, the host 102, the database 104, and each data source 106 may include one or more computing devices 300 for interacting with other components of the fraud risk determination system 100 and/or implementing one or more of process 200 shown in FIG. 2. In embodiments, the components of the system 100 can be configured to interact with each other and/or carry out the processes 200 using one or more communication networks, including, for example, a wireless communication network (e.g., WiFi, cellular, etc.) or a wired communication network (e.g., WLAN, etc.). In certain embodiments, the financial services organization 108 may access the fraud risk determination system 100 through a webpage managed by the host 102. In other embodiments, the financial services organization 108 may be required to securely log into the fraud risk determination system 100.

FIG. 3 is a block diagram of a computing device 300 housing executable software used to facilitate the fraud risk determination system 100, including one or more components thereof, in accordance with embodiments. One or more instances of the computing device 300 may be utilized to implement any, some, or all of the components in the system 100, such as, for example, the host 102, the database 104, the data sources 106 and/or the financial services organization 108. Computing device 300 includes memory element 304, which may include a computer readable medium for implementing the system 100, and/or components thereof, and for implementing particular system interactions. Memory element 304 may also be utilized to implement one or more databases 306, such as, for example, the database 104 for storing transaction information, as shown in FIG. 1. Computing device 300 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 300 may be representative of any computer in which the system 100 resides or partially resides.

Generally, in terms of the hardware architecture as shown in FIG. 3, computing device 300 includes processor 302, memory 304, and one or more input and/or output (I/O) devices 308 (or peripherals) that are communicatively coupled via a local interface 310. Local interface 310 may be one or more buses or other wired or wireless connections, as is known in the art. Local interface 310 may have additional elements, which are omitted for simplicity, such as controllers, buffers (caches), drivers, transmitters, and receivers to facilitate external communications with other like or dissimilar computing devices. Further, local interface 310 may include address, control, and/or data connections to enable internal communications among the other computer components.

Processor 302 is a hardware device for executing software, particularly software stored in the memory 304. Processor 302 can be any custom made or commercially available processor, such as, for example, a Core series or vPro processor made by Intel Corporation, or a Phenom, Athlon or Sempron processor made by Advanced Micro Devices, Inc. In the case where computing device 300 is a server, the processor may be, for example, a Xeon or Itanium processor from Intel, or an Opteron-series processor from Advanced Micro Devices, Inc. Processor 302 may also represent multiple parallel or distributed processors working in unison.

Memory 304 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). Memory 304 may incorporate electronic, magnetic, optical, and/or other types of storage media. Memory 304 can have a distributed architecture where various components are situated remote from one another, but are still accessed by processor 302. These other components may reside on devices located elsewhere on a network or in a cloud arrangement.

The software in memory 304 may include one or more separate programs. The separate programs comprise ordered listings of executable instructions for implementing logical functions. In the example of FIG. 3, the software in memory 304 may include the system 100, and/or the process 200, in whole or in part, in accordance with the present disclosure, and a suitable operating system (O/S) 312. Examples of suitable commercially available operating systems 312 are Windows operating systems available from Microsoft Corporation, Mac OS X available from Apple Computer, Inc., a Unix operating system from AT&T, or a Unix-derivative such as BSD or Linux. The operating system 312 will depend on the type of computing device 300, as will be appreciated. Operating system 312 essentially controls the execution of other computer programs, such as the system 100, and provides scheduling, input-output control, file and data management, memory management, and communication control and related services.

Steps and/or elements, and/or portions thereof, of the techniques described herein may be implemented using a source program, executable program (object code), script, or any other entity comprising a set of instructions to be performed. Furthermore, the software embodying these techniques can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, and Lua. Components of the system 100 may also be written in a proprietary language developed to interact with these known languages.

The I/O device 308 may interact, via the local interface 310, with interactive hardware 314 comprising one or more input devices 316, such as a keyboard, a mouse, a scanner, a microphone, a touch screen, etc. The interactive hardware 314 may also include output devices such as a display 318, a printer, an audio speaker, etc. The interactive hardware 314 may also comprise devices that communicate with the inputs or outputs, such as a communications module 320 comprising one or more of a short-range transceiver (RFID, Bluetooth, etc.), a telephonic interface, a cellular communication port, a router, or other types of network communication equipment. The interactive hardware 314 may be internal to computing device 300, or may be external and connected wirelessly or via connection cable, such as through a universal serial bus port.

When computing device 300 is in operation, processor 302 is configured to execute software stored within memory 304, to communicate data to and from memory 304, and to generally control operations of computing device 300 pursuant to the software. The system 100 and/or the process 200, and operating system 312, in whole or in part, may be read by processor 302, buffered within processor 302, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. Portions of the system 100, and/or the process 200 can be embodied in any type of computer-readable medium for use by or in connection with an instruction execution system or apparatus, such as a computer.

Referring back to FIG. 1, in some embodiments, the host 102, the database 104, the data sources 106 and/or the financial services organization 108, in whole or in part, can be implemented as computer software modules stored in a memory and operating on one or more processors associated with the system 100 or components thereof. For example, an identity verification module (not shown) may be configured, using computer software instructions stored in the memory 304 and executing on the processor 302, to carry out the operations of the process 200. In such cases, the identity verification module may be included on, or operatively coupled to, one or more computing devices 300 associated with the financial services organization 108, and may be in communication with, or have access to, the database 104 and/or the host 102.

For purposes of connecting to other computing devices, computing device 300 is equipped with network communication equipment and circuitry. In certain embodiments, the network communication equipment includes a network card such as an Ethernet card, or a wireless connection card. In a preferred network environment, each of the plurality of computing devices 300 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the present disclosure is for each computing device 300 to have a broadband or wireless connection to the Internet (such as DSL, Cable, Wireless, T-1, T-3, OC3 or satellite, etc.), the principles described herein are also practicable with a dialup connection through a standard modem or other connection means. Wireless network connections are also contemplated, such as wireless Ethernet, satellite, infrared, radio frequency, Bluetooth, near field communication, and cellular networks.

Any process descriptions or blocks in figures should be understood as representing modules, segments, or portions of code which include one or more executable instructions for implementing specific logical functions or steps in the process, and alternate implementations are included within the scope of the embodiments of the present disclosure in which functions may be executed out of order from that shown or discussed, including substantially concurrently or in reverse order, depending on the functionality involved, as would be understood by those having ordinary skill in the art.

It should be emphasized that the above-described embodiments of the present disclosure, particularly, any “preferred” embodiments, are possible examples of implementations, merely set forth for a clear understanding of the principles of the present disclosure. Many variations and modifications may be made to the above-described embodiment(s) of the present disclosure without substantially departing from the spirit and principles of the present disclosure. All such modifications are intended to be included herein within the scope of this disclosure and the present disclosure and protected by the following claims.

1. A fraud risk determination system comprising:
a processor; and
a memory device that stores a plurality of instructions that, when executed by the processor responsive to an initiated transaction, cause the processor to:
receive transaction data associated with an entity,
for each of a plurality of different fraud component models, determine, based on at least a portion of the received transaction data, an individual fraud predictor associated with that fraud component model, wherein each individual fraud predictor is determined independent of each of the other individual fraud predictors,
determine, based on a dynamic weighting of each of the determined individual fraud predictors associated with each of the fraud component models, a single identity fraud risk score associated with the entity, and
cause a display, by a display device, of the determined single identity fraud score associated with the entity.

2. The fraud risk determination system of claim 1, wherein the transaction data associated with the entity comprises personal identifying information associated with the entity.

3. The fraud risk determination system of claim 1, wherein the transaction data associated with the entity comprises inquiry data associated with the entity.

4. The fraud risk determination system of claim 1, wherein the transaction data associated with the entity comprises population segment data associated with the entity.

5. The fraud risk determination system of claim 1, wherein at least one of the fraud component models comprises a true name fraud component model.

6. The fraud risk determination system of claim 1, wherein at least one of the fraud component models comprises a synthetic fraud component model.

7. The fraud risk determination system of claim 1, wherein at least one of the fraud component models comprises a fraud rules optimization fraud component model.

8. The fraud risk determination system of claim 1, wherein at least one of the fraud component models comprises a fraud susceptibility fraud component model.

9. The fraud risk determination system of claim 1, wherein the dynamic weighting of each of the determined individual fraud predictors associated with each of the fraud component models comprises weighting a first individual fraud predictor determined for a first of the fraud component models more than a second, different individual fraud predictor determined for a second, different of the fraud component models.

10. The fraud risk determination system of claim 9, wherein the first individual fraud predictor is associated with a greater probability of a fraud being committed than the second, different individual fraud predictor.

11. A method of operating a fraud risk determination system responsive to an initiated transaction, the method comprising:
receiving transaction data associated with an entity,
for each of a plurality of different fraud component models, determining, by a processor and based on at least a portion of the received transaction data, an individual fraud predictor associated with that fraud component model, wherein each individual fraud predictor is determined independent of each of the other individual fraud predictors,
determining, by the processor and based on a dynamic weighting of each of the determined individual fraud predictors associated with each of the fraud component models, a single identity fraud risk score associated with the entity, and
displaying, by a display device, the determined single identity fraud score associated with the entity.

12. The method of claim 11, wherein the transaction data associated with the entity comprises personal identifying information associated with the entity.

13. The method of claim 11, wherein the transaction data associated with the entity comprises inquiry data associated with the entity.

14. The method of claim 11, wherein the transaction data associated with the entity comprises population segment data associated with the entity.

15. The method of claim 11, wherein at least one of the fraud component models comprises a true name fraud component model.

16. The method of claim 11, wherein at least one of the fraud component models comprises a synthetic fraud component model.

17. The method of claim 11, wherein at least one of the fraud component models comprises a fraud rules optimization fraud component model.

18. The method of claim 11, wherein at least one of the fraud component models comprises a fraud susceptibility fraud component model.

19. The method of claim 11, wherein the dynamic weighting of each of the determined individual fraud predictors associated with each of the fraud component models comprises weighting, by the processor, a first individual fraud predictor determined for a first of the fraud component models more than a second, different individual fraud predictor determined for a second, different of the fraud component models.

20. The method of claim 19, wherein the first individual fraud predictor is associated with a greater probability of a fraud being committed than the second, different individual fraud predictor.

21. The fraud risk determination system of claim 1, wherein a first determined single identity fraud score associated with the entity is displayed as a first color and a second, different determined single identity fraud score associated with the entity is displayed as a second, different color.

22. The fraud risk determination system of claim 1, wherein the memory device stores a plurality of further instructions that, when executed by the processor responsive to a receipt of data associated with an input to display at least one of the determined individual fraud predictors, cause the processor to cause a display, by the display device, of that at least one of the determined individual fraud predictors.

23. The method of claim 11, wherein a first determined single identity fraud score associated with the entity is displayed as a first color and a second, different determined single identity fraud score associated with the entity is displayed as a second, different color.

24. The method of claim 11, further comprising, responsive to a receipt of data associated with an input to display at least one of the determined individual fraud predictors, displaying, by the display device, that at least one of the determined individual fraud predictors.
